(19) United States
(12) Patent Application Publication
(10) Pub. No.: US 2026/0122460 A1
(43) Pub. Date: Apr. 30, 2026

(54) System and Method for Vehicle-to-Vehicle Emergency Beacon for Autonomous Vehicle Emergency

(71) Applicant: Torc Robotics, Inc., Blacksburg, VA (US)

(72) Inventors: William Gray DAVIS, Austin, TX (US); Joseph R. FOX-RABINOVITZ, Austin, TX (US)

(21) Appl. No.: 18/927,577

(22) Filed: Oct. 25, 2024

(51) Int. Cl. H04W 4/46; B60Q 1/50; G07C 5/08; H04R 27/00

(52) U.S. Cl. CPC H04W 4/46; B60Q 1/5035; G07C 5/0808; H04R 27/00

(57) ABSTRACT

An emergency alert message notification device including at least one memory configured to store machine executable instructions, and at least one processor coupled to the at least one memory is disclosed. The emergency alert message notification device is configured to execute the instructions to perform operations including (i) periodically receiving a health check signal from a plurality of components of an autonomous vehicle; (ii) upon determining at least one health check signal was not received from a component of the plurality of components, determining an emergency alert message notification; and (iii) transmitting the emergency alert message notification to notify other vehicles in proximity of the autonomous vehicle.

### TECHNICAL FIELD

The field of the disclosure relates generally to a vehicle-to-vehicle (V2V) emergency beacon for an autonomous vehicle to communicate in emergency situations.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Generally, when a non-autonomous vehicle or a semi-autonomous vehicle experiences an internal problem causing the vehicle to potentially cause a safety risk for other vehicles, a driver of the vehicle communicates to its neighbors on the road. However, when an autonomous vehicle experiences such an internal problem, the autonomous vehicle generally lacks a driver to notify other vehicle users of the potential safety risk.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an emergency alert message notification device including at least one memory configured to store machine executable instructions and at least one processor coupled to the at least one memory is disclosed. The at least one processor is configured to execute the instructions to perform operations including: (i) periodically receiving a health check signal from a plurality of components of an autonomous vehicle; (ii) upon determining at least one health check signal was not received from a component of the plurality of components, determining an emergency alert message notification; and (iii) transmitting the emergency alert message notification to notify other vehicles in proximity of the autonomous vehicle.

In another aspect, a method is disclosed. The method includes: (i) periodically receiving, at an emergency alert message notification device positioned at an autonomous vehicle, a health check signal from a plurality of components of the autonomous vehicle; (ii) upon determining, by the emergency alert message notification device, at least one health check signal was not received from a component of the plurality of components, determining an emergency alert message notification; and (iii) transmitting, by the emergency alert message notification device, the emergency alert message notification to notify other vehicles in proximity of the autonomous vehicle.

In yet another aspect, an autonomous vehicle including an emergency alert message notification device, a plurality of components, and a communication interface is disclosed. The emergency alert message notification device includes at least one memory configured to store machine executable instructions, and at least one processor coupled to the at least one memory. The plurality of components is communicatively coupled with the emergency alert message notification device that is configured to execute the instructions to (i) periodically receive a health check signal from the plurality of components; (ii) upon determining at least one health check signal was not received from a component of the plurality of components, determine an emergency alert message notification; and (iii) transmit, via the communication interface, the emergency alert message notification to notify at least one other vehicle in proximity of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is a block diagram of an example emergency alert message notification device; and

FIG. 5 is a flow diagram of an embodiment method of broadcasting or transmitting an emergency alert notification message.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, an alert corresponding to a condition detected with an autonomous vehicle to other vehicles in proximity of the autonomous vehicle, as described herein.

Various embodiments in the present disclosure describe a method to detect a condition on an autonomous vehicle that potentially poses a safety risk to other vehicles in proximity of the autonomous vehicle and notify the other vehicles using a vehicle-to-vehicle (V2V) beacon to communicate severity of the condition on the autonomous vehicle. In certain embodiments, V2V communication more generally is employed to communicate the severity of the condition. In particular, the V2V beacon (or V2V communication) defines a protocol for transmitting one or more predetermined emergency alert messages including, but not limited to, “an alert message,” “a stay alert message,” “a keep clear alert message,” etc. For example, “an alert message” may be used to notify other vehicles in proximity of the autonomous vehicle that the autonomous vehicle is no longer properly functioning. Similarly, “a stay alert message” may be used to notify other vehicles in proximity of the autonomous vehicle that the autonomous vehicle has lost control, and “a keep clear alert message” may be used to notify the other vehicles that the autonomous vehicle has come to an emergency stop, and assistance from another vehicle would be helpful.

The emergency alert message may be transmitted or broadcasted using a code. For example, the code may be a numeric code or an alphanumeric code of predetermined length. Each code may have an associated alert message description that may be displayed as an audiovisual message, or played as an audio message, to a user of another vehicle in proximity of the autonomous vehicle. The emergency alert message may further include at least one of a vehicle identifier and a current location of the autonomous vehicle. The vehicle identifier may include one or more of a make and a model of the autonomous vehicle, a license plate number of the autonomous vehicle, and color of the autonomous vehicle. The current location of the autonomous vehicle may be transmitted as latitude and longitude coordinates of the autonomous vehicle or using a map identifying currently location of the autonomous vehicle. The current location of the autonomous vehicle and the vehicle identifier may be transmitted or broadcasted in a locally meaningful reference frame. The reference frame defines a location and movement based on a commonly understood point. A global reference frame has generally latitude and longitude. In the present disclosure, the reference frame is understood normally to be the road and mile markers.

The emergency alert message may be periodically transmitted or broadcasted, for example, until the condition is resolved, or assistance is received. For example, the emergency alert message may be transmitted or broadcasted over one or more short range techniques such as, Citizens Band Radio (CB Radio) or Bluetooth. CB Radio in the United States range from 26.965 to 27.405 MHz, with 40 channels spaced 10 kHz apart. In other countries, or regions, different frequency range with different spacing may be used for CB Radio. Additionally, or alternatively, cellular technologies like 4G, 5G, etc., may also be used for transmitting or broadcasting of the emergency alert message. The emergency alert message may be transmitted or broadcasted as a short message service (SMS). The SMS may be transmitted or broadcasted to other vehicles or users of other vehicles in a predetermined radius area surrounding the autonomous vehicle. The predetermined radius area may be 1 mile or 1 kilometer, for example. The emergency alert message may be transmitted to mission control in addition to other vehicles in proximity of the autonomous vehicle.

In an example embodiment, a device (or module) that is independent of the rest of the autonomous vehicle may be determine whether a condition for transmitting or broadcasting an emergency alert message is present. For example, and without limitation, the device may be battery powered and communicate with different components of an autonomy computing system using, for example, a heartbeat signal. The heartbeat signal may also be referenced herein as a health check signal. The heartbeat signal, for example, may be a periodic communication between the device and one or more different components of the autonomy computing system. The heartbeat signal can be a broadcast, unicast or multicast packet of a predetermined length. The heartbeat signal may be used to indicate the hardware or software components are operating normally.

Alternatively, an ECU of the autonomous vehicle may communicate with different components of the autonomy computing system using, for example, a heartbeat signal. Components of the autonomy computing system may periodically send a heartbeat signal to the device or the ECU. Additionally, or alternatively, different components of the autonomy computing system may have a different or the same periodicity for the heartbeat signal. Upon determining that one or more periodic heartbeats are missed from a component of the autonomy computing system, depending on the component from which the one or more periodic heartbeats are missed, a particular emergency alert message may be determined for transmission or broadcasting. Additionally, or alternatively, depending on a total number of components from which periodic heartbeats are missed, the particular emergency alert message may be determined for transmission or broadcasting.

For example, the device or the ECU may be communicatively coupled with different components of the autonomy computing system, for example, using a communication bus, a vehicle controller area network (CAN) bus, etc. The device or the ECU may be communicatively coupled with components of the autonomous vehicle including, components of the autonomy computing system, or to receive a health check signal from a respective sensor monitoring functioning of a component or a module of the autonomous vehicle. The health check signal may suggest one or more different problems and based upon a specific problem identified by the health check signal, the emergency alert message may be determined for transmission or broadcasting.

Accordingly, as an example, if an autonomous vehicle is about to lose power, the device or the ECU may periodically transmit the emergency alert message. In this case, the emergency alert message may act as a tracking beacon for an emergency medical service (EMS) provider or mission control to locate the autonomous vehicle and provide assistance as soon as possible or without struggling to identify an accurate location of the autonomous vehicle. Additionally, or alternatively, other autonomous vehicles in proximity of the autonomous vehicle transmitting or broadcasting an emergency alert message may be configured to respond to the emergency alert message.

In the embodiments disclosed herein, the device may be separate from the ECU, or integrated with the ECU. Accordingly, the device separate from the ECU may also identify a condition with the ECU using a heartbeat signal or a health check signal, as described herein. In some embodiments, the autonomous vehicle may announce details of the emergency alert message using a loudspeaker or display details of the emergency alert message using an electronic sign board, positioned at the autonomous vehicle.

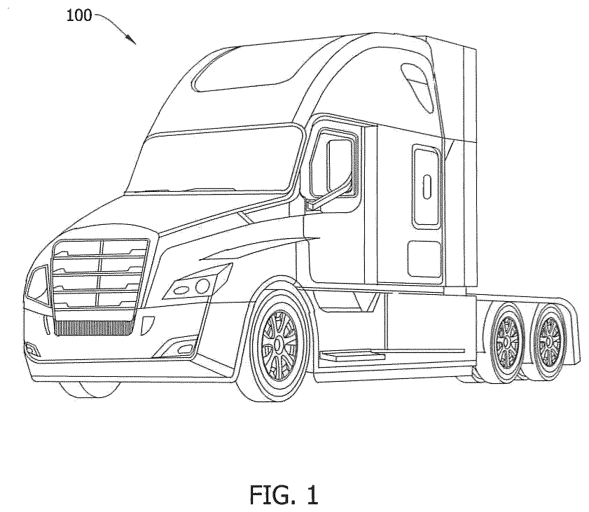

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

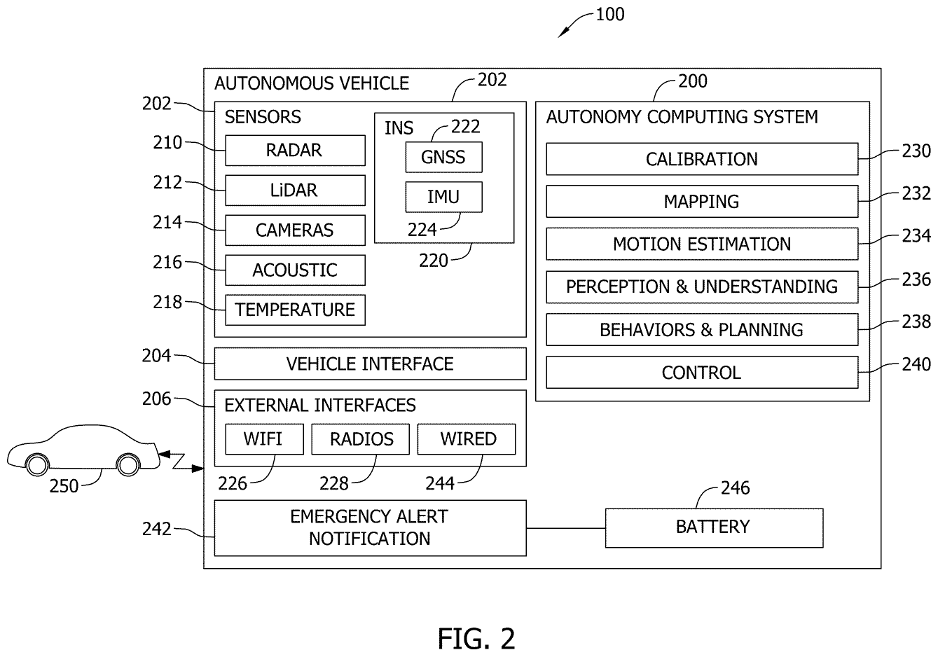

FIG. 2 is a block diagram of autonomous vehicle 100 shown in FIG. 1. In the example embodiment, autonomous vehicle 100 includes autonomy computing system 200, sensors 202, a vehicle interface 204, external interfaces 206, and an emergency alert notification device (or an emergency alert notification module) 242.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). Emergency alert notification device 242 communicates with other components of autonomy computing system 200 via vehicle interface 204. Vehicle interface 204 may be, for example, a CAN bus or another suitable communication bus. External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.). Radios 228 may be configured to provide dedicated short-range radio communication (DSRC) for V2V communication, for example, between autonomous vehicle 100 and another vehicle 250. Additionally, or alternatively, V2V communication may be facilitated using at least one of 5G and Bluetooth. The other vehicle 250 may be an autonomous vehicle, a semi-autonomous vehicle, or a non-autonomous vehicle, equipped with V2V communication capability.

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The emergency alert notification device 242 may be powered using a separate source (e.g., a battery) 246 dedicated to supply electrical power to the emergency alert notification device 242 only. Alternatively, functionality of the emergency alert notification device 242 may be integrated into autonomy computing system 200 and powered using a separate source (e.g., a battery) dedicated to supply power to the emergency alert notice device 242 integrated into autonomy computing system 200. The source providing power to the emergency alert notification device 242 may be a rechargeable battery, or a solar powered battery, etc.

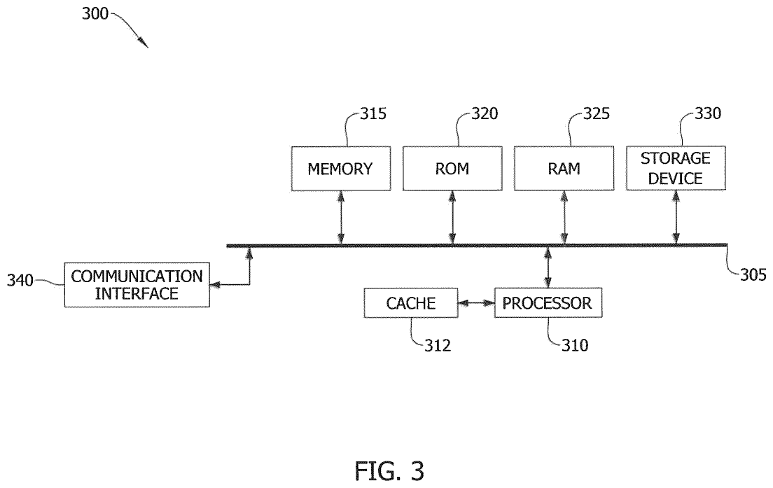

FIG. 3 illustrates an example computing system 300 that can implement various techniques, processes, functions, or methods described herein. Computing system 300 may be embodied within, for example, autonomous vehicle 100 shown in FIG. 1. The components of computing system 300 are shown in electrical communication with each other using a connection 305, such as a communication bus. The example computing system 300 includes a processing unit (ECU, CPU, or processor) 310 and a computing device connection 305 that couples various computing device components, including computing device memory 315, such as a read only memory (ROM) 320 and a random-access memory (RAM) 325, to processor 310.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

The processor 310 may implement functions of the emergency alert notification device 242, for example, periodically receiving a health check signal from a plurality of components of autonomous vehicle 100, and upon determining that at least one health check signal was not received from a component of the plurality of components, determining and transmitting an emergency alert message notification to notify one or more other vehicles in proximity of autonomous vehicle 100. The processor 310 may be communicatively coupled with the plurality of components of autonomous vehicle 100 using a CAN bus or a communication bus. The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

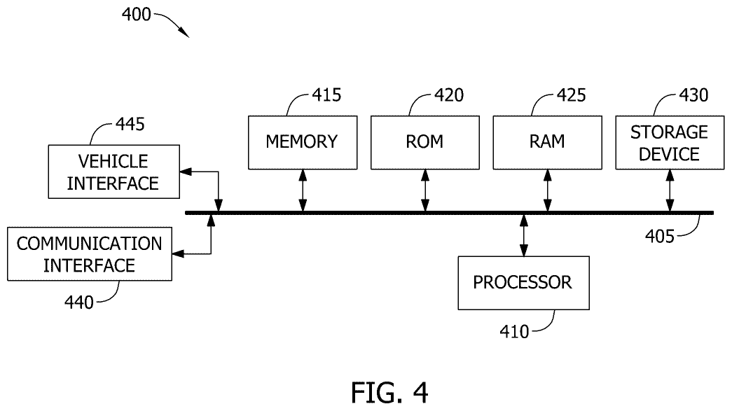

FIG. 4 is a block diagram of an example emergency alert message notification device 400 such as, the emergency alert message notification device 242 shown in FIG. 2. The components of emergency alert message notification device 400 are shown in electrical communication with each other using a connection 405, such as a communication bus. The example emergency alert message notification device 400 includes a processing unit (CPU, or processor) 410 and the connection 405 that couples the processing unit 410 with memory 415, such as a read only memory (ROM) 420 and a random-access memory (RAM) 425, to processor 410. A separate power source (e.g., a battery, not shown in FIG. 4) may supply electrical power to the emergency alert message notification device 400 such that the emergency alert message notification device 400 can function uninterrupted.

Processor 410 can include any general-purpose processor, central processing unit (CPU), or graphics processing unit (GPU) in combination with a hardware or software provision configured to control processor 410 and stored in storage device 430, as well as any special-purpose processor where software instructions are incorporated into the processor design. Processor 410 may be a self-contained system, containing multiple cores or processors, a bus, memory controller, cache, etc. A multi-core processor may be symmetric or asymmetric.

Storage device 430 is a non-volatile memory and can be one or more of a hard disk or other types of computer readable media that can store data that are accessible by a computer, such as a magnetic cassette, flash memory card, solid state memory device, digital versatile disk, cartridge, RAM 425, ROM 420, or hybrids thereof. Memory 415 or storage device 430 can include software, code, firmware, etc., for controlling processor 410. Other hardware or software modules are contemplated. Memory 415 and storage device 430 are connected to computing device connection 405. In one aspect, a hardware module that performs a particular function can include the software component stored in a computer-readable medium in connection with the necessary hardware components, such as processor 410, connection 405, and so forth, to carry out the function. In the example embodiment, processor 410 may be programmed by encoding an operation or function using one or more executable instructions and providing the executable instructions in memory 415 or storage device 430.

The processor 410 may implement functions of the emergency alert notification device 242, for example, periodically receiving a health check signal from a plurality of components of autonomous vehicle 100, and upon determining that at least one health check signal was not received from a component of the plurality of components, determining and transmitting an emergency alert message notification to notify one or more other vehicles in proximity of autonomous vehicle 100. The processor 410 may be communicatively coupled with the plurality of components of autonomous vehicle 100 using a vehicle interface 445 such as, a CAN bus or a communication bus. The processor 410 may be communicatively coupled with a communication interface 440 to communicate with external entities such as, mission control, or one or more other vehicles using V2V communication. Accordingly, the communication interface 440 may include one or more of radio interfaces configured for at least one of: (i) a vehicle-to-vehicle communication technique, (ii) citizens band radio frequencies; (iii) a Bluetooth signal; and (iv) a short message service (SMS) technology. The vehicle interface may be also coupled with an electronic sign board mounted on autonomous vehicle 100, or a public address system or a loudspeaker positioned at autonomous vehicle 100 for displaying or announcing details of the emergency alert message notification.

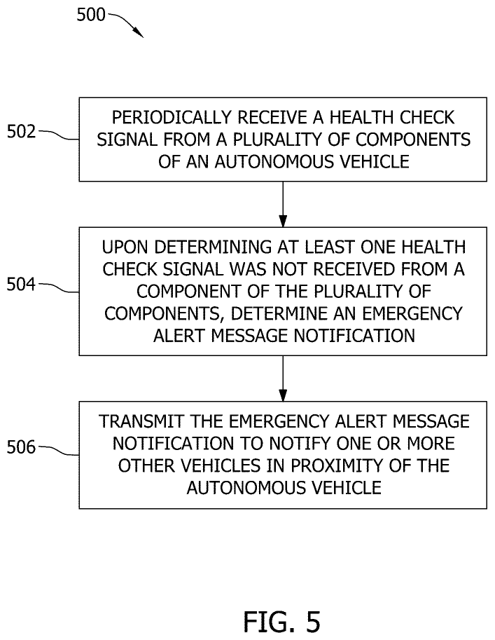

FIG. 5 is an example flow-chart 500 of method operations for providing an emergency alert notification message to other vehicles or their users in proximity of autonomous vehicle 100 upon determining a fault or a condition with one or more components of autonomous vehicle 100 affecting a safe operation of autonomous vehicle 100. The method operations include periodically receiving 502, at an emergency alert message notification device 242 positioned at an autonomous vehicle 100, a health check signal from a plurality of components of the autonomous vehicle. The plurality of components may include at least one sensor. The plurality of components is communicatively coupled with the emergency alert message notification device 242.

The method operations include upon determining that at least one health check signal was not received from a component of the plurality of components, determine 504 an emergency alert message notification, and transmit 506 the emergency alert message notification to notify at least one other vehicle in proximity of the autonomous vehicle. For example, the emergency alert message notification is transmitted by broadcasting the emergency alert message notification using at least one of: (i) a vehicle-to-vehicle communication technique, (ii) citizens band radio frequencies; (iii) a Bluetooth signal; and (iv) a short message service (SMS) technology. The emergency alert message notification may be periodically transmitted.

Additionally, or alternatively, details the emergency alert message notification may be displayed on an electronic sign board mounted on autonomous vehicle 100, or announced using a public address system or a loudspeaker positioned at autonomous vehicle 100. The emergency alert message notification may be transmitted to mission control for displaying on a roadside electronic sign board that is on the current route of autonomous vehicle 100.

As described herein, the emergency alert message notification is determined based on at least one of: (i) determining from which component of the plurality of components of the autonomous vehicle the at least one health check signal was not received, and (ii) determining a total number of missed health check signals. The emergency alert message notification, as described herein, includes a code associated with a particular emergency alert message notification description. The emergency alert message notification also includes at least one of an identifier of the autonomous vehicle or a current location of the autonomous vehicle. The identifier of the autonomous vehicle includes at least one of a license plate detail of the autonomous vehicle, a color of the autonomous vehicle, or a make and a model of the autonomous vehicle.

An example technical effect of the methods, systems, and apparatus described herein includes at least improving safety of an autonomous vehicle and other road users in the case of a failure of a component of the autonomous vehicle that poses safety risk to the autonomous vehicle or other road users.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An emergency alert message notification device comprising:
at least one memory configured to store machine executable instructions; and
at least one processor coupled to the at least one memory and configured to execute the machine executable instructions to perform operations comprising:
periodically receiving a health check signal from a plurality of components of an autonomous vehicle;
upon determining at least one health check signal was not received from a component of the plurality of components, determining an emergency alert message notification; and
transmitting the emergency alert message notification to notify other vehicles in proximity of the autonomous vehicle.

2. The emergency alert message notification device of claim 1, wherein transmitting the emergency alert message notification comprises broadcasting the emergency alert message notification using a vehicle-to-vehicle communication technique.

3. The emergency alert message notification device of claim 1, wherein transmitting the emergency alert message notification comprises broadcasting the emergency alert message notification using citizens band radio frequencies.

4. The emergency alert message notification device of claim 1, wherein transmitting the emergency alert message notification comprises broadcasting the emergency alert message notification as a Bluetooth signal.

5. The emergency alert message notification device of claim 1, wherein transmitting the emergency alert message notification comprises broadcasting the emergency alert message notification using a short message service (SMS) technology.

6. The emergency alert message notification device of claim 1, wherein the emergency alert message notification comprises a code associated with a particular emergency alert message notification description.

7. The emergency alert message notification device of claim 1, wherein the emergency alert message notification further comprises at least one of an identifier of the autonomous vehicle or a current location of the autonomous vehicle.

8. The emergency alert message notification device of claim 7, wherein the identifier of the autonomous vehicle comprises at least one of a license plate detail of the autonomous vehicle, a color of the autonomous vehicle, or a make and a model of the autonomous vehicle.

9. The emergency alert message notification device of claim 1, wherein transmitting the emergency alert message notification comprises periodically transmitting the emergency alert message notification.

10. The emergency alert message notification device of claim 1, wherein transmitting the emergency alert message notification comprises:
displaying details of the emergency alert message notification on an electronic sign board mounted on the autonomous vehicle; or
transmitting the emergency alert message notification to mission control for displaying on a roadside electronic sign board.

11. The emergency alert message notification device of claim 1, wherein transmitting the emergency alert message notification comprises announcing the emergency alert message notification through a public address system or a loudspeaker positioned at the autonomous vehicle.

12. The emergency alert message notification device of claim 1, wherein the emergency alert message notification is determined based on at least one of: (i) determining from which component of the plurality of components of the autonomous vehicle the at least one health check signal was not received, and (ii) determining a total number of missed health check signals.

13. The emergency alert message notification device of claim 1, wherein the emergency alert message notification device is coupled with a power source providing electrical power to the emergency alert message notification device.

14. A method comprising:
periodically receiving, at an emergency alert message notification device positioned at an autonomous vehicle, a health check signal from a plurality of components of the autonomous vehicle;
upon determining, by the emergency alert message notification device, at least one health check signal was not received from a component of the plurality of components, determining an emergency alert message notification; and
transmitting, by the emergency alert message notification device, the emergency alert message notification to notify other vehicles in proximity of the autonomous vehicle.

15. The method of claim 14, wherein transmitting the emergency alert message notification comprises broadcasting the emergency alert message notification using at least one of: (i) a vehicle-to-vehicle communication technique, (ii) citizens band radio frequencies; (iii) a Bluetooth signal; and (iv) a short message service (SMS) technology;
wherein the emergency alert message notification comprises a code associated with a particular emergency alert message notification description, and at least one of an identifier of the autonomous vehicle or a current location of the autonomous vehicle; and
wherein the identifier of the autonomous vehicle comprises at least one of a license plate detail of the autonomous vehicle, a color of the autonomous vehicle, or a make and a model of the autonomous vehicle.

16. The method of claim 14, wherein transmitting the emergency alert message notification comprises periodically transmitting the emergency alert message notification, and wherein the emergency alert message notification device is coupled with a power source providing electrical power to the emergency alert message notification device.

17. The method of claim 14, wherein transmitting the emergency alert message notification comprises:
displaying details of the emergency alert message notification on an electronic sign board mounted on the autonomous vehicle; or
transmitting the emergency alert message notification to mission control for displaying on a roadside electronic sign board; or
announcing the emergency alert message notification through a public address system or a loudspeaker positioned at the autonomous vehicle.

18. The method of claim 14, further comprising determining the emergency alert message notification based on at least one of: (i) determining from which component of the plurality of components of the autonomous vehicle the at least one health check signal was not received, and (ii) determining a total number of missed health check signals.

19. An autonomous vehicle comprising:
an emergency alert message notification device comprising at least one memory configured to store machine executable instructions, and at least one processor coupled to the at least one memory;
a plurality of components including at least one sensor, the plurality of components is communicatively coupled with the emergency alert message notification device; and
a communication interface,
wherein the emergency alert message notification device is configured to execute the machine executable instructions to:
periodically receive a health check signal from the plurality of components;
upon determining at least one health check signal was not received from a component of the plurality of components, determine an emergency alert message notification; and
transmit, via the communication interface, the emergency alert message notification to notify at least one other vehicle in proximity of the autonomous vehicle.

20. The autonomous vehicle of claim 19, wherein the communication interface includes a radio interface; and
wherein to transmit the emergency alert message notification, the emergency alert message notification device is further configured to execute the machine executable instructions to:
broadcast the emergency alert message notification using at least one of: (i) a vehicle-to-vehicle communication technique, (ii) citizens band radio frequencies; (iii) a Bluetooth signal; and (iv) a short message service (SMS) technology.
